(19) United States
(12) Patent Application Publication
(10) Pub. No.: US 2023/0351790 A1
(43) Pub. Date: Nov. 2, 2023

(54) Methods and systems to identify the type of a document by matching reference features

(71) Applicant: IDEMIA IDENTITY & SECURITY USA LLC, RESTON, VA (US)

(72) Inventors: Hui ZHU, rESTON, VA (US); Brian Martin, Reston, VA (US)

(21) Appl. No.: 17/731,287

(22) Filed: Apr. 28, 2022

(51) Int. Cl. G06V 30/418; G06V 10/82; G06V 10/771; G06V 30/414; G06V 10/772; G06V 10/12

(52) U.S. Cl. CPC G06V 30/418; G06V 10/12; G06V 10/771; G06V 10/772; G06V 10/82; G06V 30/414; G06V 10/24

(57) ABSTRACT

A method for identifying a type of a document comprising:
obtaining a document image,
processing the image of the document in a neural network configured to receive a document image and to deliver a feature for each portion of a plurality of portions of the document image, to obtain a plurality of features each associated with a portion of the document image,
obtaining a set of reference features each associated with a document type and a location within a document,
matching each reference features of the set of reference features with a feature of the plurality of features to identify the type of the document.

### FIELD

The disclosure relates generally to the authentication of identity documents, and more particularly to identifying the type of a document based on an image of this document.

### BACKGROUND

Today’s increasing demand for online and mobile verification of identity documents has created a strong need for authentication solutions with various fraud detection capabilities. The main goal of these solutions is to determine that a document is genuine and not altered.

A first step of authentication solutions concerns the identification of the type of document (i.e. passport, driving licence, identification card, etc.) so as to subsequently be able to verify that the security features of each type of document are present.

There exist solutions that are based on the dimensions of the documents. The ISO/CEI 7810 standard (in all its versions) defines a plurality of known document dimensions (for example ID-000, ID-1, ID-2, ID-3) that can be used to identify a type of document. This is however not sufficient as various documents may have the same dimensions.

In some countries such as in the USA, each state may use a different driving licence format. An authentication system should, by way of example, be able to determine the state associated with a driving licence, so as to know where the relevant information can be read (typically name, date of birth, bar code, etc.).

There exist methods to identify a type of document that use deep learning based global matching that operate in a manner which is similar to face recognition methods. These methods are not satisfactory as a large number of sample images remains required, and the performance of these methods also remains inadequate for most applications. In particular, these methods may fail on document types that have minor differences between them.

There also exist methods known to the person skilled in the art as “SIFT: Scale Invariant Feature Transform”. These methods may still fail on document types that have minor differences between them.

### BRIEF SUMMARY

Systems and methods for identifying types of documents and for authenticating documents are disclosed.

The disclosure provides a method for identifying a type of a document comprising:
obtaining a document image (for example a digital image, which may have been acquired by a device configured to capture an image of a document configured to be observed using visible light, infrared light, ultraviolet light, or other types of light),
processing the document image in a neural network configured to receive a document image and deliver a feature for each portion of a plurality of portions of the document image, to obtain a plurality of features each associated with a portion of the document image,
obtaining a set of reference features each associated with a document type and a location within a document (of said type associated with the reference feature), matching each reference features of the set of reference features with a feature of the plurality of features to identify the type of the document.

This method therefore proposes to perform a matching, neither between entire images, nor between portions of the images directly, but between features obtained by a neural network that correspond to portions and reference features. This has been observed to be faster than comparisons between document images or portions of document images. Using the above method therefore also improves authenticating documents in terms of speed.

It should be noted that the features are neural network outputs (sometimes referred to as features by persons skilled in the art), typically vectors having a given length (for example 64). This is also the case for the reference features which have preferably the same dimensions as the features obtained from the neural network.

The reference features can be features obtained by using the above mentioned neural network that correspond to reference portions of document images (also called reference images). Matching vectors having the same dimensions is particularly efficient in terms of computing time.

By selecting the reference features for each type of document that reflect the specificities of each type of document, an even more efficient method is obtained. As each reference feature along with its associated location in the document image is associated with a type of document, the possible types of documents that can be determined are set by the reference features and their locations. Also, if there are minor differences between documents of different types, selecting the reference features should be performed to reflect these minor differences.

The neural network encoded feature is incorporated with the location information, so that the matching takes into account the location in the document image of the portion: a better matching is obtained when a graphical element is at the location associated with a reference feature also obtained at this location.

According to a particular embodiment, the method comprises matching each reference feature with a feature associated with a portion of the document image corresponding to the location of the reference feature.

In this particular embodiment, each reference feature, which is associated with a location (typically a location within a pixel matrix that forms an image of a document, or a location within a grid), will be matched with features that have the same location in the image of the document, as this location corresponds to the location of the reference feature.

By corresponding to what is meant is that the location is the one of the reference feature.

According to a particular embodiment, the method comprises matching each reference feature with a feature associated with a portion of the document image located in the image at the location associated with the reference feature or within a distance from the location associated with the reference feature.

This particular embodiment allows accommodating errors in the step of obtaining the document image, for example in a preliminary step of standardizing the image document.

As digital images of documents may not be perfectly aligned when these images are acquired, it has been observed that a better identification of the type is obtained when reference features are matched with features at the same location or within a distance (typically at plus or minus a given number of pixels, horizontally and/or vertically). Hence, for one reference feature, a matching step is performed using several features outputted by the neural network around the location associated with the reference feature.

According to a particular embodiment, obtaining a document image comprises obtaining an initial image on which a document is visible, detecting the borders of the document in the initial image, extracting the document (the pixels contained within the borders) from the initial image and adjusting the orientation and the resolution of the extracted document to obtain the document image.

It has been observed that document images may not be perfectly aligned and/or have a resolution that differs from an expected resolution (for example 150 DPI). For example, the images may not be aligned within the pixel matrix as were the images used to obtain the reference features and this can be corrected by an orientation adjustment in accordance with a given orientation. The images may also have a resolution (expressed for example in DPI) which differs from the expected resolution and a scaling (upscaling or downscaling) may have to be performed) to adjust the resolution.

According to a particular embodiment, the portions of the document image all have the same dimensions.

This particular embodiment facilitates obtaining features that can be matched with reference features.

According to a particular embodiment, the portions of the document image are arranged in accordance with a grid having a given pitch smaller than the width and/or the height of all the portions.

The inventors of the present disclosure have observed that using a grid having a pitch smaller than the width/height of all the portions provides overlapping portions of the document image. This increases the possibility of having portions of the document image that correspond to the reference portions of the document image used to obtain the reference features, if the reference features are features obtained by using the above mentioned neural network that correspond to reference portions of an image of a document.

According to a particular embodiment, the document is a personal document.

A personal document is a document associated with a particular person, for example a passport, an identification card, a driving licence, etc. Typically, personal information is visible on this document and on images of this document, for example, this personal information has been printed. Security features may also be present on the personal document so as to facilitate performing an authentication of the personal document.

According to a particular embodiment, the features of the plurality of features and the reference features of the set of reference features are vectors having a given length.

According to a particular embodiment, matching each reference features of the set of reference features with a feature of the plurality of features includes:
computing an individual score for each reference feature, and
computing, for each possible type of document, a document score based on the individual scores of the reference features associated with this possible type of document,
determining the document type of the document based on the document scores.

According to a particular embodiment, the method comprises a preliminary training phase of the neural network.

By way of example, the preliminary training phase of the neural network may comprise a processing of document images by the neural network. The training will consist in adapting the parameters of the neural network (for example using the stochastic gradient method) so that portions of images of document that correspond, at the same location, to a same pattern, lead to obtaining features that are close and remote otherwise.

According to a particular embodiment, the method comprises a preliminary step of enrolling a reference feature comprising:
obtaining an image of a reference document (this reference document having a known type, also, this step may include a step of detecting the border and adjusting the orientation and the resolution),
selecting a portion of the image of the reference document to obtain a reference image having a reference location,
processing the reference image in the neural network (the one used to obtain the plurality of features, which may be configured to accept images having different resolutions as input) to obtain a reference feature associated with the reference location and the type of the reference document,
adding the reference feature to the set of reference features.

Here, the reference image is visible on the reference document. Multiple reference images can be obtained from a single document, to obtain multiple reference features to be added to the set of reference features. Multiple images of references documents can be used, especially documents of different types.

These reference images therefore amount to portions of images of documents.

Preferably, the reference images are chosen to as to represent a type of document. By way of example, the reference images can be portions of symbols that only appear within a given type of document at a given location.

By way of example, the reference images are delimited manually.

According to a particular embodiment, the method comprises a preliminary step of enrolling a reference feature comprising:
obtaining an image of a reference document (this reference document having a known type, also, this step may include a step of detecting the border and adjusting the orientation and the resolution),
processing the image of the reference document in the neural network (the one used to obtain the plurality of features) to obtain a plurality of intermediary features,
selecting an intermediary feature as the reference feature associated with a location in the image of the reference document.

In this alternative embodiment, the entire image of the reference document is processed by the neural network and the feature is selected after the processing by the neural network.

According to a particular embodiment, the reference document is a personal document including visible personal information, and obtaining a reference image includes selecting a portion of the image of the reference document distinct from the visible personal information.

In this particular embodiment, the reference images are selected in portions that are called invariant, as they are the same for every document of a given type, regardless of the personalisation that has been carried out. In other words, they are outside of portions in which information specific to the carrier of the document is visible.

The disclosure also provides a method for authenticating a document comprising a first phase of identifying the type of the document comprising:
obtaining a document image,
processing the document image in a neural network configured to receive a document image and deliver a feature for each portion of a plurality of portions of the document image, to obtain a plurality of features each associated with a portion of the document image,
obtaining a set of reference features each associated with a document type and a location within a document,
matching each reference features of the set of reference features with a feature of the plurality of features to identify the type of the document,
wherein the method further comprises a second phase of authenticating the document in accordance with the type of the document.

The method for authenticating a document therefore includes the step of the method for identifying a type of a document as defined above, and the method for authenticating a document can be adapted to include the steps of any one of the particular embodiments of the method for identifying a type of a document.

The second phase of authenticating the document can include verifying the presence of a security feature in the document image, this security feature being specific to the type of the document.

The disclosure also provides a system for identifying a type of a document comprising:
a processor,
a memory storing instructions that, when executed by the processor, cause the processor to implement:
   a module configured to obtain a document image,
   a neural network configured to process the document image, the neural network being configured to receive a document image and to deliver a feature for each portion of a plurality of portions of the document image, to obtain a plurality of features each associated with a portion of the document image,
   a module configured to obtain a set of reference features each associated with a document type and a location within a document,
   a module configured to match each reference features of the set of reference features with a feature of plurality of features having, and configured to identify the type of the document.

This system can be adapted to perform any one of the particular embodiments of the method for identifying a type of a document as defined above.

According to a particular embodiment, the system comprises a camera or a scanner.

The camera or the scanner can provide document images to the module configured to obtain a document image. This camera or scanner can for example be a camera or scanner of a document-reader machine. Also, the system can comprise multiple cameras and/or scanners.

According to a particular embodiment, the system comprises a light source configured to light up the document observed by the camera or scanner, wherein the light source emits visible light, infrared light, or ultraviolet light.

In this particular embodiment, the camera or scanner obtains a digital image, acquired when the document is lit up by visible light, infrared light, or ultraviolet light.

The disclosure also provides a system for authenticating a document comprising:
a processor,
a memory storing instructions that, when executed by the processor, cause the processor to implement:
a module configured to obtain a document image,
a neural network configured to process the document image, the neural network being configured to receive a document image and to deliver a feature for each portion of a plurality of portions of the document image, to obtain a plurality of features each associated with a portion of the document image,
a module configured to obtain a set of reference features each associated with a document type and a location within a document,
a module configured to match each reference features of the set of reference features with a feature of plurality of features having, and configured to identify the type of the document,
a module for authenticating the document in accordance with the type of the document.

This system can include the system for identifying a type of a document as defined above.

The disclosure also provides a non-transitory computer useable medium having stored thereon instructions that, when executed by a processor, cause the processor to perform a method for identifying a type of a document comprising:
obtaining a document image,
processing the document image in a neural network configured to receive a document image and to deliver a feature for each portion of a plurality of portions of the document image, to obtain a plurality of features each associated with a portion of the document image,
obtaining a set of reference features each associated with a document type and a location within a document,
matching each reference features of the set of reference features with a feature of plurality of features having to identify the type of the document.

In one particular embodiment, the steps of the method are determined by computer program instructions.

Consequently, the disclosure is also directed to a computer program for executing the steps of a method for identifying a type of a document as described above when this program is executed by a computer.

This program can use any programming language and take the form of source code, object code or a code intermediate between source code and object code, such as a partially compiled form, or any other desirable form.

The disclosure is also directed to a computer program for executing the steps of a method for authenticating a document as described above when this program is executed by a computer.

This program can use any programming language and take the form of source code, object code or a code intermediate between source code and object code, such as a partially compiled form, or any other desirable form.

The disclosure is also directed to a computer-readable information medium containing instructions of a computer program as described above (for identifying a type of a document or for authenticating a document).

The information medium can be any entity or device capable of storing the program. For example, the medium can include storage means such as a ROM, for example a CD ROM or a microelectronic circuit ROM, or magnetic storage means, for example a diskette (floppy disk) or a hard disk.

Alternatively, the information medium can be an integrated circuit in which the program is incorporated, the circuit being adapted to execute the method in question or to be used in its execution.

### BRIEF DESCRIPTION OF THE DRAWINGS

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 is a representation of a document of a first type.

FIG. 2 is a representation of a document of a second type.

FIG. 3 illustrates a grid used to divide an image of a document into portions.

FIG. 4 shows the steps carried out to obtain the set of reference features.

FIG. 5 illustrates schematically the steps of a method for identifying a document.

FIG. 6 shows how an individual score is computed.

FIG. 7 shows how, from individual scores, a document score is computed.

FIG. 8 shows a system according to an example.

### DETAILED DESCRIPTION OF EMBODIMENTS

We will now describe methods and systems for identifying the type of documents. To perform the identification, a neural network is used to process images and to deliver a feature (a neural network output vector) for each portion of a plurality of portions of the document image, to obtain a plurality of features each associated with a portion of the document image.

This neural network can have the structure of a fully convolutional neural network, having connexions between neurons that delimit the different portions of the image. Here, the last convolution layer of this neural network outputs a feature vector for each portion of the image.

By way of example, the neural network may have a structure adapted from the neural network structures known to the person skilled in the art as ResNet or VGGNet. The adaptation of these known structures can include selecting a layer of these structures as the output layer of the present neural network, for example a layer outputting neural network vectors having a desired length.

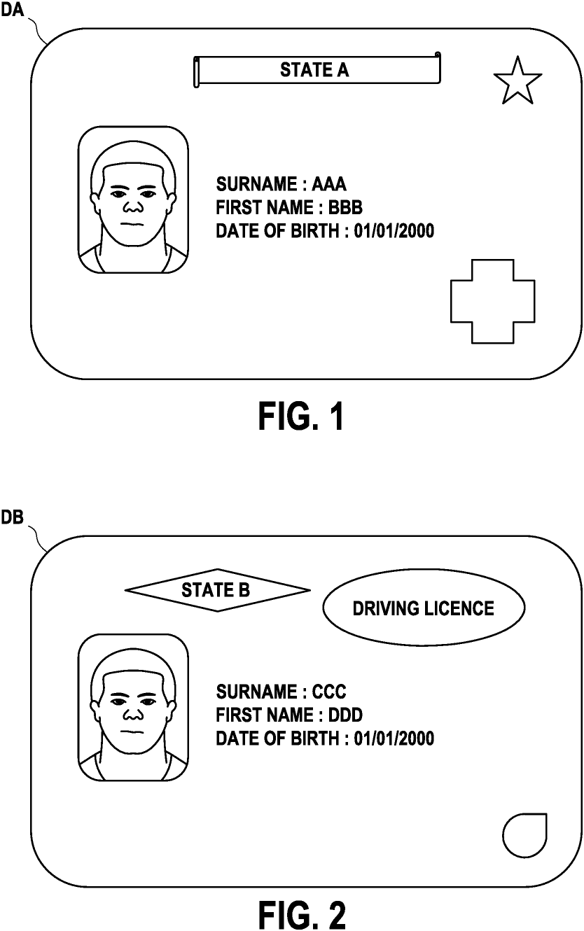

FIG. 1 is an image of a document of a first type DA (the image of a document is also called a document image). For example, this image can be a digital image acquired by a camera.

As can be seen on the figure, the document is a personal document. By personal document, what is meant is that the document is associated with a user and/or personal information visible on the document/on the image.

Here, document DA comprises a picture of a face and personal information (surname, first name, date of birth). What indicates the type of document is the other information visible on the image, here the name of a state (“A”) indicated in a ribbon, and other symbols that may be associated with this state (a star in the upper right corner and a cross in the bottom right corner). Thus, document DA is an identification card for state A.

FIG. 2 is an image of another document of a second type DB. This image can also be a digital image acquired by a camera.

Document DB has a type which differs from the type of document DA as it is a driving licence (indicated in an ellipse in the upper right corner), it is associated with state “B”, and does not show the ribbon, the star, and the cross of document DA. Instead, the state is indicated in a diamond-shape symbol, and there is a drop-shaped symbol in the bottom right corner.

The present method for identifying is directed, for example, to identifying whether a document is an identification card from state A, or a driving licence from state B. The method is not limited to these two types and applies to any document type (and the associated states or sub-types). The document types therefore can be passport, identity card, driving licence (each according to any state or country), and any other personal identification documents.

Once a document type has been identified as will be explained hereinafter, an authentication according to this type can be performed.

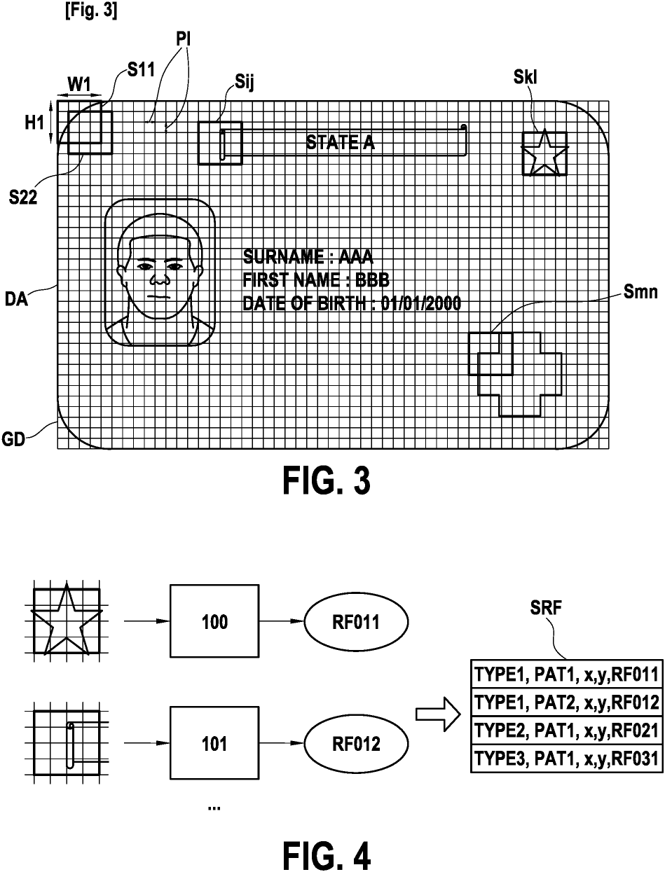

FIG. 3 illustrates a grid used to divide an image of a document into portions. This figure illustrates how the neural network which will be described hereinafter processes images it receives as input.

It should be noted that by dividing the image, what is meant is that when the image is inputted to the neural network used in the present method, a plurality of features are outputted that respectively correspond to different portions of the image. Hence, the connexions between the artificial neurons of this neural network will perform dividing the image into portions (such as S11, S22 in FIG. 3). Since the neighboured portions at pixel interval are so similar, their features extracted by the neural network may also be very similar. Therefore, for efficiency, it is preferable to extract the features at a grid interval such as grid GD visible on FIG. 3.

Here, the image is of a document DA as described in reference to FIG. 1 and the grid GD is shown superimposed on this document. The grid GD represents how portions of the image which will all have the same dimensions will correspond respectively to the features outputted by the neural network. Furthermore, the grid GD is configured so that the pitch PI of the grid is much smaller than the width W1 and the height H1 of all the portions (all the portions have the same width W1 and the same height H1, with W1=H1). The pitch PI is both a vertical and horizontal pitch.

It should be noted that in the present application, distances, heights, widths, and pitch can be expressed in number of pixels. For example, the portions can have a width of 40 pixels and a height of 40 pixels, and the pitch PI can be of 8 pixels. These dimensions are merely illustrative examples and can be set in accordance with the resolution of the printing method used to obtain the documents and in accordance with the resolution of the camera used to acquire the images of the documents (typically expressed in dots per inch (dpi), for example 150 dpi). The dimensions of the portions may also be set in accordance with the size of the symbols visible on the images of documents (such as the star on document DA).

On the figure, the portions of the image are designated using matrix indexes. For example, the top left portion is designated as S11, and the next one diagonally is designated as S22.

It should be noted that symbols in document DA are adapted to be used as reference images and more precisely portion Sij that comprises a portion of ribbon, portion Skl that comprises the star, and portion Smn that comprises a corner of the cross.

The three portions Sij, Skl, and Smn are selected as distinct from the portions of the image of document DA in which personal information is visible: they are invariant on all the documents of the type of document DA.

It should be noted that on FIG. 3, the document image DA has been obtained using the following steps: obtaining an initial image (for example using a camera or a scanner), detecting the borders of the document in the initial image, extracting the document from the initial image and adjusting the orientation and the resolution of the extracted document to obtain document image DA.

This results in a document image having left, right, top, and bottom borders that coincide with the borders of the grid GD of FIG. 3.

FIG. 4 shows how, in a preliminary step of enrolling reference features and how the neural network which will be used to obtain reference features, to obtain the set of reference features.

In step 100, the portion of the image of document DA (or of any other document of the same type, for example, an image of a reference document) which has been selected as it includes the star visible in portion Skl in FIG. 3 is inputted and processed by the neural network.

Step 100, which corresponds to obtaining a single neural network feature, delivers reference feature RF011 (the neural network accepts as input images of different resolutions).

Other reference images as used in the training phase, for example and as shown, the portion Sij in which the portion of ribbon is visible is processed by the neural network in step 101 to obtain reference feature RF012.

Once all the reference features for all the difference types of document have been obtained, a storing step is carried out in which the set of reference features SRF is added/stored with every feature RF0ab, with a an index indicating the type of document and b the number of the reference feature for this document. The coordinates x, y in the grid GD are also stored, as well as the type of document (TYPE1 for document DA, TYPE2 for document DB, TYPE3 for another type of document) and an identifier for each feature PATi.

It should be noted that alternatively, enrolling reference feature can include processing, using the neural network entire document images and subsequently selecting reference features.

By way of example, a preliminary training phase of the neural network may have been carried out in which images of documents are also processed by the neural network. The training will consist in adapting the parameters of the neural network (for example using the stochastic gradient method) so that portions of images of document that correspond, at the same location, to a same pattern, lead to obtaining features that are close and remote otherwise.

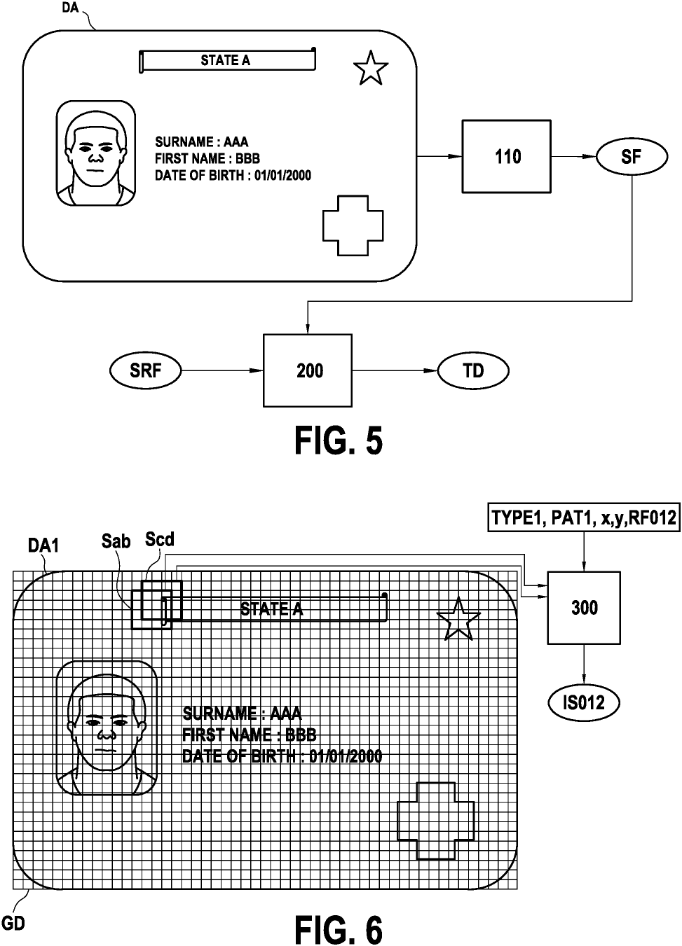

FIG. 5 shows how an image of a document DA1 (of the same type as document DA shown on FIG. 1) will be processed. Document DA1 can be a personalised document, with personal information of a user visible on the face of the document shown on the figure.

In step 110, the document image DA1 is processed by the neural network (for example after it has been trained).

This allows obtaining, for each portion of the plurality of portions of the document image (divided in accordance with the above-described grid GD), a respective feature. A set of features SF, i.e. a plurality of features, is then obtained.

The set of reference features described in reference to FIG. 4 is then obtained (for example retrieved from a memory) to perform step 200 of matching each reference feature with a feature (one or more features) of the set of features SF to identify the type of the document DA1.

Matching a reference feature will now be described in more detail and according to an example in reference to FIG. 6. On this figure, the image of document DA1 described in reference to FIG. 5 is shown with the grid GD superimposed above it.

The matching of reference feature RF012 is performed by obtaining the features (using the neural network) that are associated with a portion of the document image located at the location x, y provided along the reference feature or within a distance from this location (for example at plus or minus 20 pixels horizontally or vertically).

Hence, features for the portions of image Sab and Scd will both be used in step 300 (which is included in the matching step), in which an individual score IS012 will be computed for reference feature RF012. This matching score can be the highest score delivered by a matching algorithm that compares the features of portions Sab and Scd with the reference feature RF012. The L2 normalization matching algorithm of the two feature vectors and calculating the inner product of the two normalized vectors. A score can be obtained comprised between [-1:1], with 1 indicating a perfect match.

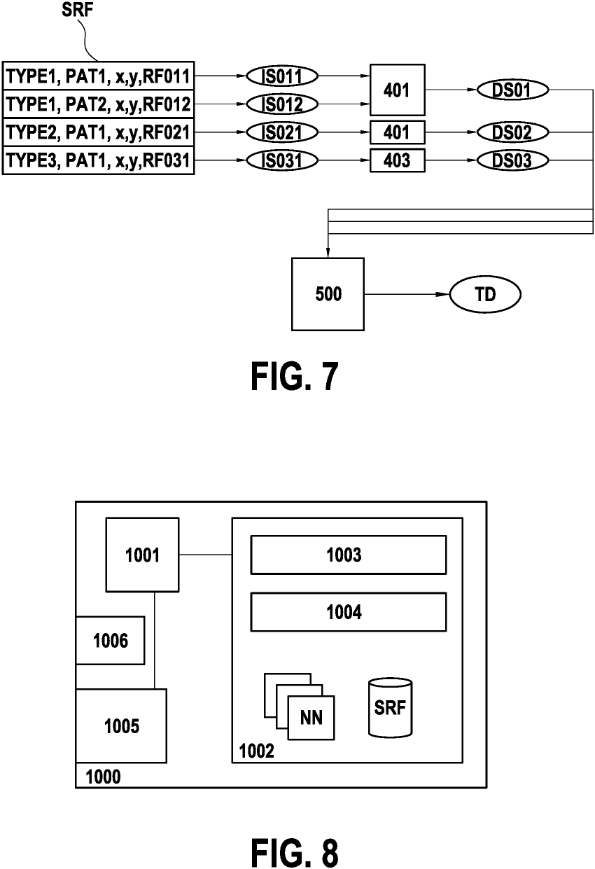

FIG. 7 shows schematically how document scores are computed in the matching step. Following the steps described in reference to FIG. 6 above, individual scores IS011 and IS012 have been obtained for potential document type TYPE1 (the type of documents DA and DA1), individual score IS21 has been obtained for potential document type TYPE2 (for example the type of document DB), and individual score IS31 has been obtained for potential document type TYPE3.

In step 401, individual scores IS011 and IS012 are used to compute document score DS01 for document type DS01. This computation can comprise computing the mean score (or a weighted mean score) between the plurality of individual scores that are associated with the same document type, or determining the highest individual score and using this highest individual score as the document score. Other types of individual score combination can be used to get the document score.

For document types TYPE2 and TYPE3, as only one individual score has been obtained, this individual score can be used as the document score.

Subsequently, step 500 is performed to determine the highest document score and, in accordance with this highest document score, the document type TD is determined. From this document type TD, an authentication step can then be carried out.

FIG. 8 shows a system 1000 according to an example.

This system has the structure of a computer and comprises a processor 1001 and a non-volatile memory 1002. In the non-volatile memory 1002, computer program instructions 1003 are stored that, when executed by a processor, cause the processor to perform a method for identifying a type of a document comprising:
obtaining a document image,
processing the document image in a neural network configured to receive a document image and to a feature for each portion of a plurality of portions of the document image, to obtain a plurality of features each associated with a portion of the document image,
obtaining a set of reference features each associated with a document type and a location within a document,
matching each reference features of the set of reference features with a feature of the plurality of features to identify the type of the document.

The non-volatile memory 1002, to perform the above method, also stores the neural network NN used in the method, and the set of reference features SRF.

Furthermore, the non-volatile memory 1004 includes instructions that, when executed by the processor, perform an authentication of the document according to the type of document determined previously.

It should be noted that system 1000 includes a camera 1005 able to acquire images of documents on which the above mentioned methods can be performed. This camera is optional and the system 1000 can also receive images of documents through a communication interface. The camera may be replaced by a scanner.

Also, the system 1000 includes a light source 1006 configured to light up the document observed by the camera 1005, wherein the light source emits visible light, infrared light, or ultraviolet light.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present disclosure should not be limited by any of the above-described exemplary embodiments, but should be defined only in accordance with the following claims and their equivalents.

1. A method for identifying a type of a document comprising:
obtaining a document image,
processing the document image in a neural network configured to receive a document image and to deliver a feature for each portion of a plurality of portions of the document image, to obtain a plurality of features each associated with a portion of the document image,
obtaining a set of reference features each associated with a document type and a location within a document,
matching each reference features of the set of reference features with a feature of the plurality of features to identify the type of the document.

2. The method of claim 1, further comprising matching each reference feature with a feature associated with a portion of the document image corresponding to the location of the reference feature.

3. The method of claim 2, further comprising matching each reference feature with a feature associated with a portion of the document image located in the image at the location associated with the reference feature or within a distance from the location associated with the reference feature.

4. The method of claim 1, wherein obtaining a document image comprises obtaining an initial image on which a document is visible, detecting the borders of the document in the initial image, extracting the document from the initial image and adjusting the orientation and the resolution of the extracted document to obtain the document image.

5. The method of claim 1, wherein the portions of the document image all have the same dimensions.

6. The method of claim 1, wherein the portions of the document image are arranged in accordance with a grid having a given pitch smaller than the width and/or the height of all the portions.

7. The method of claim 1, wherein the document is a personal document.

8. The method of claim 1, wherein the features of the plurality of features and the reference features of the set of reference features are vectors having a given length.

9. The method of claim 1, wherein matching each reference features of the set of reference features with a feature of the plurality of features includes
computing an individual score for each reference feature, and
computing, for each possible type of document, a document score based on the individual scores of the reference features associated with this possible type of document,
determining the document type of the document based on the document scores.

10. The method of claim 1, further comprising a preliminary training phase of the neural network.

11. The method of claim 1, further comprising a preliminary step of enrolling a reference feature comprising:
obtaining an image of a reference document,
selecting a portion of the image of the reference document to obtain a reference image having a reference location,
processing the reference image in the neural network to obtain a reference feature associated with the reference location and the type of the reference document,
adding the reference feature to the set of reference features.

12. The method of claim 1, further comprising a preliminary step of enrolling a reference feature comprising:
obtaining an image of a reference document,
processing the image of the reference document in the neural network to obtain a plurality of intermediary features,
selecting an intermediary feature as the reference feature associated with a location in the image of the reference document.

13. The method of claim 11, wherein the reference document is a personal document including visible personal information, and obtaining a reference image includes selecting a portion of the image of the reference document distinct from the visible personal information.

14. A system for identifying a type of a document comprising:
a processor,
a memory storing instructions that, when executed by the processor, cause the processor to implement:
a module configured to obtain a document image,
a neural network configured to process the document image, the neural network being configured to receive a document image and to deliver a feature for each portion of a plurality of portions of the document image, to obtain a plurality of features each associated with a portion of the document image,
a module configured to obtain a set of reference features each associated with a document type and a location within a document,
a module configured to match each reference features of the set of reference features with a feature of plurality of features having, and configured to identify the type of the document.

15. The system of claim 14, further comprising a camera or a scanner.

16. The system of claim 15, further comprising a light source configured to light up the document observed by the camera or scanner, wherein the light source emits visible light, infrared light, or ultraviolet light.

17. A non-transitory computer useable medium having stored thereon instructions that, when executed by a processor, cause the processor to perform a method for identifying a type of a document comprising:
obtaining a document image,
processing the document image in a neural network configured to receive a document image and to deliver a feature for each portion of a plurality of portions of the document image, to obtain a plurality of features each associated with a portion of the document image,
obtaining a set of reference features each associated with a document type and a location within a document,
matching each reference features of the set of reference features with a feature of the plurality of features to identify the type of the document.
